(19) United States
(12) Patent Application Publication
(10) Pub. No.: US 2024/0091746 A1
(43) Pub. Date: Mar. 21, 2024

(54) A kind of supported Ru and/or Ni catalyst and preparation method thereof

(71) Applicant: FZU Zijin Hydrogen Power Technology Co., Ltd., Fuzhou City (CN)

(72) Inventors: Lilong JIANG, Fuzhou City (CN); Chongqi CHEN, Fuzhou City (CN); Yu LUO, Fuzhou City (CN); Jun NI, Fuzhou City (CN); Qing ZHANG, Fuzhou City (CN)

(73) Assignees: FZU Zijin Hydrogen Power Technology Co., Ltd., Fuzhou City (CN); Fuzhou University, Fuzhou (CN)

(21) Appl. No.: 18/373,246

(22) Filed: Sep. 26, 2023

(30) Foreign Application Priority Data
Sep. 16, 2022 (CN) 202211127938.0

(51) Int. Cl. B01J 23/46; B01J 6/00; B01J 23/755; B01J 35/00; B01J 37/02; B01J 37/04; B01J 37/08

(52) U.S. Cl. CPC B01J 23/462; B01J 6/001; B01J 23/755; B01J 35/0006; B01J 37/0209; B01J 37/0213; B01J 37/04; B01J 37/08

(57) ABSTRACT

A method for preparing a supported Ru and/or Ni catalyst includes mixing a magnesium precursor, a zinc precursor, or a nickel precursor with an aluminum precursor in solid phase to form a first mixture; adding an auxiliary agent to the first mixture to form a second mixture, wherein the auxiliary agent is to increase a specific surface area; calcining the second mixture at a first temperature to obtain a spinel carrier; placing the spinel carrier in a solution of a Ru and/or Ni metal salt to impregnate the spinel carrier with the Ru and/or Ni metal salt to obtain an impregnated carrier; and after drying, calcining the impregnated carrier at a second temperature to obtain the supported Ru and/or Ni catalyst.

### REFERENCE TO RELATED APPLICATIONS

This claims the priority of Chinese Application No. 202211127938.0, filed on Sep. 16, 2022. The disclosure of which is incorporated by reference in its entirety.

### TECHNICAL FIELD

The invention belongs to the field of metal spinel carrier catalysts, in particular to a supported Ru and/or Ni catalyst and a preparation method thereof.

### BACKGROUND

At present, the widely used ammonia decomposition catalysts in industry use Ru, Rh, Fe, Ni, Mo, etc. as active components, supported on Al₂O₃ or MgO carrier. For example, U.S. Pat. No. 5,188,811 introduces a gas ammonia decomposition catalyst made of Mo and Ti. At a reaction temperature of 700-900° C., the catalyst can decompose a small amount of NH₃ in the gas into N₂ and H₂. Another example is the Chinese patent CN1141214A, which uses magnesium oxide as the carrier and nickel as the active component. The spherical catalyst prepared by the impregnation method can meet the high temperature requirements of 1300° C. Chinese patent CN1245737A describes a kind of ammonia decomposition catalyst, with molybdenum and nickel as active components, loaded on the Al₂O₃ carrier, and the conversion rate of NH₃ is greater than 99.8% at 750° C. Patent CN102188977A discloses an ammonia decomposition catalyst and its preparation method, using magnesium oxide as a carrier to prepare a honeycomb catalyst by impregnating the carrier with the active component nickel. The catalyst can be used at a temperature of 1300° C. In addition, Chinese patent CN108031474A discloses a coke oven gas ammonia decomposition catalyst and a preparation method thereof, in which aluminum sol, magnesium nitrate, and rare earth nitrate are dissolved in deionized water to prepare a mixed solution, allowing the components to react with each other, and then dry the solution, and granulate the residue to obtain a carrier. The catalyst is obtained by impregnating the nickel-molybdenum mixed solution on the carrier. However, the preparation methods of these catalysts are relatively complicated, and the texture characteristics of the generated catalysts are not suitable. The reaction area is small, and the pore sizes are not suitable, resulting in low ammonia decomposition activities of the catalysts.

### SUMMARY

In view of the above-mentioned drawbacks of the prior art, the present invention discloses supported Ru and/or Ni catalysts and preparation methods thereof to solve the technical problems due to the preparation method being relatively complicated and the pore sizes of the generated catalyst being unsuitable.

In order to achieve the above object, according to an embodiment of the present invention, a method for preparing a supported Ru and/or Ni catalyst, comprising the following steps:
S1. Preparation of spinel carrier (spinel-type carrier) by a solid phase method: mixing a magnesium precursor, a zinc precursor, or a nickel precursor with an aluminum precursor in solid phase, adding an auxiliary agent (an additive) to obtain a large specific surface area, and roasting (calcining) at the first temperature to obtain a spinel carrier;
S2. Loading Ru and/or Ni active components on the spinel carrier: placing the spinel carrier in a solution of a Ru and/or Ni metal salt, through impregnating, drying, and heating at a second temperature to obtain a supported Ru and/or Ni catalyst.

Preferably, the spinel carrier is any one of MgAl₂O₄, ZnAl₂O₄, or NiAl₂O₄;

Wherein the aluminum precursor is alumina, aluminum nitrate, pseudo boehmite, aluminum hydroxide, basic aluminum carbonate, or a combination of one or more thereof;

If the spinel carrier is MgAl₂O₄, the magnesium precursor is magnesium oxide, magnesium carbonate, magnesium hydroxide, or a combination of one or more thereof;

If the spinel carrier is ZnAl₂O₄, the zinc precursor is basic zinc carbonate, zinc nitrate, zinc hydroxide, or a combination of one or more thereof;

If the spinel carrier is NiAl₂O₄, the nickel precursor is nickel nitrate or nickel hydroxide, or a combination of one or more thereof.

Preferably, in S1, for the magnesium precursor, zinc precursor or nickel precursor, and the aluminum precursor, the molar ratio of the divalent metal Mg²⁺, Zn²⁺ and/or Ni²⁺ to Al is 0.5:1-1:4.

Preferably, the auxiliary agent (additive) is polyphosphoric acid, boric acid, silicic acid, sodium silicate, phosphate, or a combination of one or more thereof.

Preferably, the weight proportion of the auxiliary agent is: 0.5-10 wt % of the total weight.

Preferably, in S1, the first temperature is 500-700° C., and the heating rate is 1-10° C./min.

Preferably, in S2, the impregnation is repeated several times, the drying temperature is 70-120° C., and the drying time is 0.5-24 h.

Preferably, in S2, the supported Ru and/or Ni catalyst, the loading amount of Ru and/or Ni is as follows: Ni accounts for 10-30 wt % of the total weight, and Ru accounts for 0.5-12 wt % of the total weight.

Preferably, in S2, the Ni salt is Ni(NO₃)₂, NiCl₂, Ni(CH₃COO)₂, or a combination of one or more thereof; the Ru salt is Ru(NO₃)₃, RuCl₃, K₂RuO₄, or a combination of one or more thereof.

To achieve the above objective, according to an embodiment of the present invention, the present invention provides supported Ru and/or Ni catalysts prepared by the above preparation methods.

The beneficial effects of the present invention include: in accordance with embodiments of the invention, the synthesis of the spinel carrier adopts a solid-phase reaction, i.e., a solid-solid reaction. The reaction raw materials are all solid. Affected by mass and heat transfer, the solid phase reaction needs to be carried out at a certain high temperature. The reaction speed is slow, the formed product is uniform, and there is no waste liquid discharge. The present invention also adds a certain amount of an auxiliary agent to the reactants, so that the reactants can achieve higher diffusion rates at a lower temperature. Then, reactions occur to achieve spinel oxides having large specific surface areas (in the embodiments, >100 m²/g) and suitable pore size distributions. Then, these spinel oxides are used as carriers to load active metals by impregnation (or multiple impregnations), so that the active metals are evenly loaded on the outer surface of the carrier particles and the inner surface of the pores, thereby improving the dispersions of active metals and achieving higher catalyst reactivities.

### BRIEF DESCRIPTION OF DRAWINGS

FIG. 1 shows a flow chart for preparing a supported Ru and/or Ni catalyst in accordance with an embodiment of the present invention;

FIG. 2 shows nitrogen adsorption-desorption isotherm curves of catalysts prepared by the methods of Examples 1 and 2 of the present invention;

FIG. 3 shows pore size distribution curves of catalysts prepared by the methods of Examples 1 and 2 of the present invention.

### DETAILED DESCRIPTION

In order to describe in detail the possible application scenarios, technical principles, specific solutions that can be implemented, goals and effects that can be achieved, etc., the following will be described in detail in conjunction with the listed specific embodiments and accompanying drawings. The embodiments described herein are only used to illustrate the technical solutions of the present application more clearly, and they are only examples and should not be used to limit the protection scope of the present invention.

Reference herein to an “embodiment” means that a particular feature, structure, or characteristic described in connection with the embodiment can be included in at least one embodiment of the present application. The word “embodiment” appearing in various positions in the specification does not necessarily refer to the same embodiment, nor does it specifically limit its independence or relationship with other embodiments. In principle, in this description, as long as there is no technical contradiction or conflict, each technical feature mentioned in each embodiment can be combined in any way to form a corresponding implementable technical solution.

Unless otherwise defined, the meanings of the technical terms used herein are the same as those commonly understood by those skilled in the art to which the invention belongs; the use of relevant terms herein is only to describe specific embodiments and is not intended to limit the application.

Hereinafter, embodiments of the present application will be specifically disclosed in details with reference to the drawings as appropriate. However, unnecessary detailed description may be omitted. For example, detailed descriptions of well-known items and repeated descriptions of substantially the same configurations may be omitted. This is to prevent the following description from becoming unnecessarily lengthy and to facilitate the understanding for those skilled in the art. In addition, the drawings and the following descriptions are provided for those skilled in the art to fully understand the present invention and are not intended to limit the subject matter described in the claims.

A “range” as disclosed herein is defined in terms of lower and upper limits, and a given range is defined by selecting a lower limit and an upper limit that define the boundaries of the particular range. Ranges defined in this manner may be inclusive or exclusive and may be combined arbitrarily, i.e., any lower limit may be combined with any upper limit to form a range. For example, if ranges of 60-120 and 80-110 are listed for a particular parameter, it is understood that ranges of 60-110 and 80-120 are also contemplated. Additionally, if the minimum range values 1 and 2 are listed, and if the maximum range values 3, 4, and 5 are listed, the following ranges are all expected: 1-3, 1-4, 1-5, 2-3, 2-4 and 2-5. In this description, unless otherwise stated, the numerical range “a-b” represents an abbreviated representation of any combination of real numbers between a and b, where a and b are both real numbers. For example, the numerical range “0-5” represents that all real numbers between 0 and 5 have been listed in this description, and “0-5” is only an abbreviated representation of the combination of these values. In addition, when expressing that a certain parameter is an integer 2, it is equivalent to disclosing that the parameter is an integer such as 2, 3, 4, 5, 6, 7, 8, 9, 10, 11, 12, etc.

If there is no special description, all the implementation modes and optional implementation modes of the present application can be combined with each other to form new technical solutions.

If there is no special description, all the technical features and optional technical features of the present application can be combined with each other to form a new technical solution.

Unless otherwise specified, all steps in the present description can be performed sequentially or randomly, preferably sequentially. For example, the method includes steps (a) and (b), which means that the method may include steps (a) and (b) performed in sequence or may include steps (b) and (a) performed in sequence. For example, mentioning that the method may also include step (c) means that step (c) may be added to the method in any order. For example, the method may include steps (a), (b) and (c), or may include steps (a), (c) and (b), or may include steps (c), (a) and (b), and so on.

If there is no special description, the term “comprising” and “containing” mentioned in this application may include open or closed sense. For example, the “comprising” and “containing” may mean that other components not listed may be included or contained, or only the listed components are included or contained.

The terms “above” and “below” used in this description include the referenced number/subject. For example, “more than one” may refer to one or more, “more than one of A and B” may refer to “A,” “B,” or “A and B”.

In this application, the term “or” is inclusive unless otherwise stated. For example, the phrase “A or B” means “A, B, or both A and B.” More specifically, the condition “A or B” is satisfied by any of the following: A is true (or exists) and B is false (or does not exist); A is false (or does not exist) and B is true (or exists); or both A and B are true (or exist).

Unless otherwise stated, the contents and percentages in the context of the present description are based on mass.

The experimental methods described in the following examples, unless otherwise specified, are conventional methods; the reagents and materials, unless otherwise specified, can be obtained from commercial sources.

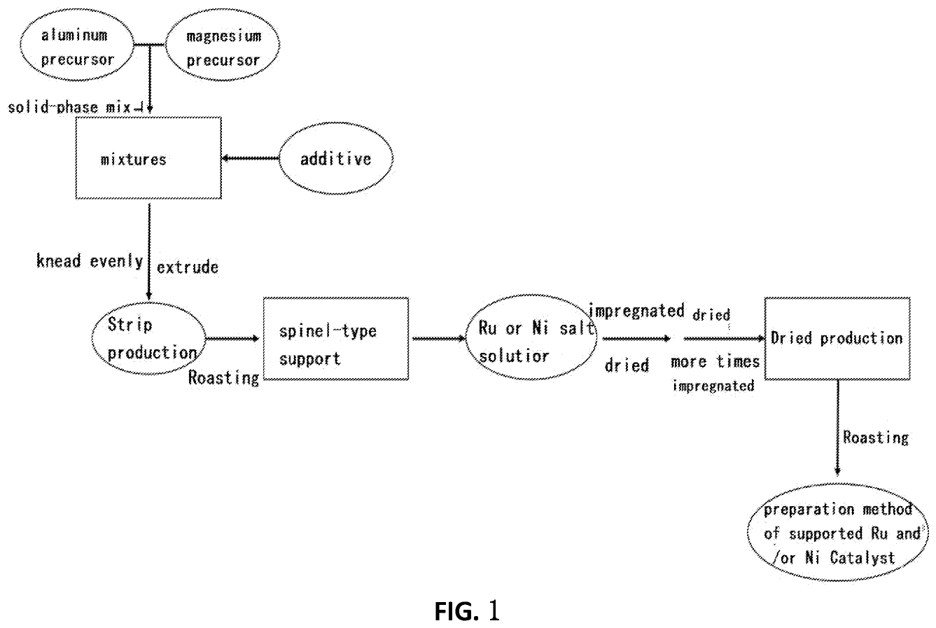

As shown in FIG. 1, the present invention provides preparation methods for loaded Ru and/or Ni catalysts. A method comprises the following steps:
S1. Preparation of a spinel carrier by a solid-phase method: mixing a magnesium precursor, a zinc precursor, or a nickel precursor with an aluminum precursor in solid phase, adding an auxiliary agent, and roasting (calcining) at a first temperature to obtain a spinel carrier;
S2. Loading Ru and/or Ni on the spinel carrier: placing the spinel carrier in a solution of Ru and/or Ni metal salt, drying after the reaction, and calcining the product at a second temperature to obtain a supported Ru and/or Ni catalyst.

### Example 1

A preparation method for a supported Ru or Ni based catalyst (can be used for ammonia decomposition, the same below), comprising the following steps:

S1, preparation of a spinel carrier/support (using MgAl₂O₄ as an example):

Preparing MgAl₂O₄ carrier in one step with a solid-phase method, the method is as follows:

Mix magnesium nitrate and aluminum nitrate with a Mg/AI molar ratio of 1:4 in a ball mill for 30 minutes in the solid phase; after thorough mixing, add 5 wt % polyphosphoric acid to the mixture; knead evenly and then extrude the mixture. The extruded product is then calcined at 600° C. for 4 hours to obtain the MgAl₂O₄ carrier;

S2, preparation of a supported Ru-based catalyst:

Weigh 2 g of the above MgAl₂O₄ carrier and place it in 10 m L solution having a metal ion concentration of 0.1 mol/L. Impregnate the MgAl₂O₄ carrier several times under the same conditions until the Ru content reaches the target loading capacity (Ru: 10 wt %). The sample was dried and then calcined at 500° C. for 4 h to afford the supported Ru catalyst.

### Example 2

A preparation method for a supported Ru or Ni-based ammonia decomposition catalyst, comprising the following steps:

S1, preparation of a spinel carrier:

A NiAl₂O₄ carrier was prepared in one step by a solid-phase method, and the steps were as follows:

Pre-mix basic zinc carbonate and aluminum hydroxide at a Zn/AI molar ratio of 1:2 in the solid phase, and mill the mixture in solid phase by grinding for 15 minutes. After mixing thoroughly, add 10 wt % sodium silicate to the mixture, and knead the mixture evenly. The mixture is extruded, and the extruded product is calcined at 550° C. for 4 hours to obtain a ZnAl₂O₄ carrier;

S2, preparation of a supported Ru—Ni based catalyst:

Weigh 2 g of the above-mentioned ZnAl₂O₄ carrier and place it in a 10 mL solution having a metal ion concentration of 0.1 mol/L. Under the same conditions, the carrier is impregnated several times until the Ru and Ni contents reach the target loading capacities (Ni: 10 wt %, Ru: 5 wt %). The dried sample was calcined at 700° C. for 4 h at a heating rate of 5° C./min to afford a supported Ru—Ni catalyst.

### Example 3

A preparation method for a supported Ru—Ni based ammonia decomposition catalyst, comprising the following steps:

The first step is to prepare a spinel carrier:

A NiAl₂O₄ support was prepared in one step by the solid phase method, and the steps were as follows:

Mix nickel nitrate and pseudo-boehmite at a Ni/AI molar ratio of 1:1.5 in the solid phase, and mix the mixture with solid phase grinding for 15 minutes. After thorough mixing, add 10 wt % boric acid to the mixture, knead evenly, and then extrude the mixture. The extruded product was calcined at 600° C. for 4 hours with a heating rate of 2° C./min to obtain a NiAl₂O₄ carrier.

The second step is to prepare a supported Ru—Ni based catalyst:

Dissolve a calculated amount of K₂RuO₄ in 10 ml water to achieve a loading capacity of 1 wt % Ru. Then, weigh 2 g of the NiAl₂O₄ carrier prepared in the first step and place it in the above solution. Impregnate the carrier several times until the Ru content reaches the target loading capacity. The dried sample was calcined at 600° C. for 4 h with a heating rate of 2° C./min to prepare a supported Ru—Ni based catalyst.

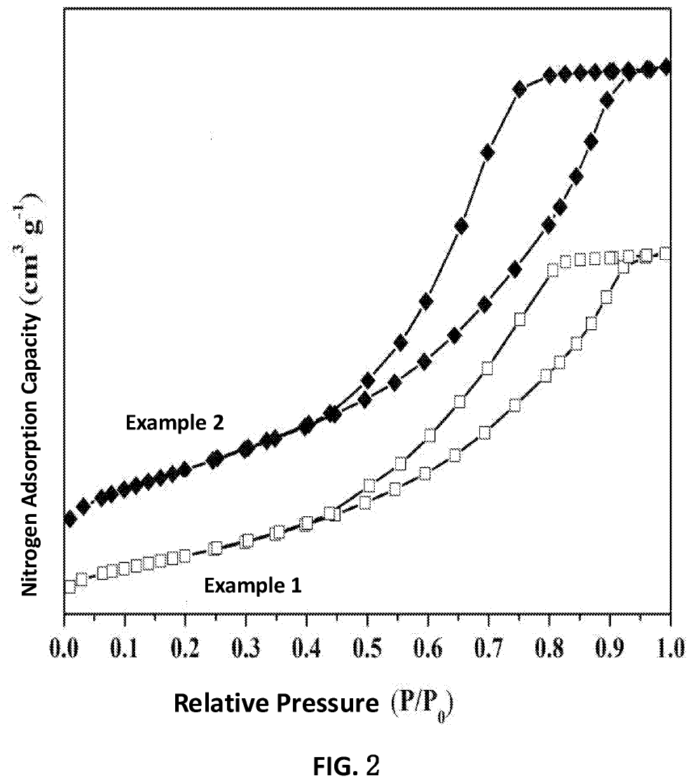

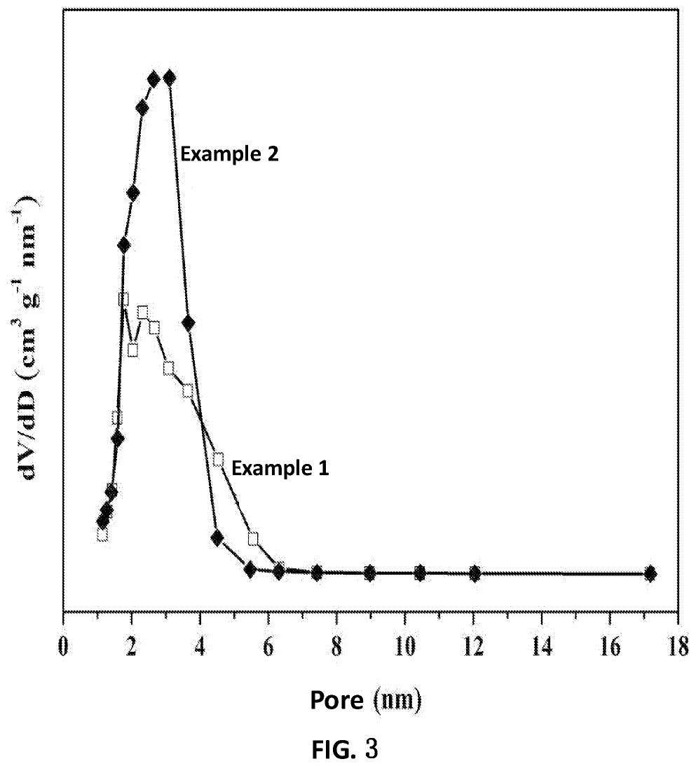

To illustrate the effects of the supported Ru—Ni based catalysts prepared according to methods of the present invention, the inventors also conducted experiments on the physical and chemical properties of the supported Ru—Ni based catalysts made in the above examples and studied the nitrogen adsorption and desorption isotherms of the catalysts and catalyst pore size distribution curves, shown respectively in FIG. 2 and FIG. 3. In addition, the structural parameters of the catalysts were also measured, as shown in Table 1. It can be seen that by adopting a method of the present invention, the most probable pore diameters of the prepared catalysts are 1.0-6.0 nm, the specific surface areas of the catalysts are large, and higher ammonia decomposition reaction efficiencies are achieved.

TABLE 1
Catalyst Structure Parameters

| sample | Example 1 | Example 2 |
|---|---|---|
| BET specific surface area (m²/g) | 105 | 155 |
| Pore volume (cm³/g) | 0.20 | 0.28 |
| Most probable pore diameter (nm) | 2.7 | 2.6 |

Among them, the catalyst nitrogen adsorption and desorption isotherm curve test method uses the ASAP 2020 instrument from American Micromeritics company. using the N₂ physical adsorption method, the catalyst nitrogen adsorption and desorption isotherm curves were measured at the liquid nitrogen temperature (−196° C.). Prior to the test, the samples were degassed in vacuum at 200° C. for 4 h. The pore size distributions of the catalysts were obtained with the Barret-Joiner-Halenda (BJH) method, and the specific surface areas of the catalysts were calculated with the Brunauer-Emmett-Teller (BET) method.

It can be seen from FIG. 2 that the adsorption-desorption isotherm curves are type IV, indicating that the catalysts have small mesopores, that the hysteresis rings are H₂ type, and that the pore structures are ink bottle like.

It can be seen from FIG. 3 that the pore sizes of the catalysts are mainly distributed in the range of 1.0-6.0 nm, being of the mesoporous structures.

### Experimental Examples

A specific application method for a supported Ru and/or Ni catalyst prepared in the above examples is as follows: the ammonia decomposition activity of the catalyst is measured in a fixed bed reactor, the feed gas is pure ammonia, the catalyst is reduced at 500° C. for 2 h, and the reaction space velocity is 10000 mL g⁻¹·h⁻¹, the catalyst activity test temperature range is 450-650° C.

The activity of the catalysts is represented by NH₃ conversion rate.

NH₃ conversion=(1−V_{NH3}′/V_{NH3})(1+V_{NH3})×100%

Wherein, V_{NH3}′ is the volume percentage of NH₃ in the reactor outlet gas, and V_{NH3} is the volume percentage of NH₃ in the feed gas. According to above-mentioned NH conversion rate formula, based on measured data, one can obtain catalytic efficiencies of Example 1, Example 2, and Example 3 at different temperatures as follows. As can be seen, even at a low temperature of 450° C., Example 1 also has a high ammonia decomposition activity. When the temperature reaches 650° C., the NH₃ conversion rates of Examples 1-3 all reached 99.8%.

TABLE 2
Catalyst ammonia decomposition activity evaluation results

| Reaction temperature (° C.) | Example 1 | Example 2 | Example 3 |
|---|---|---|---|
| 450 | 85.4 | 62.5 | 48.9 |
| 550 | 99.6 | 97.2 | 93.5 |
| 650 | 99.8 | 99.8 | 99.8 |

Finally, it is noted that the above embodiments are only used to illustrate the technical solutions of the present invention without limitation. Although the present invention has been described in detail with reference to preferred embodiments, those of ordinary skill in the art would understand that the technical solutions of the present invention can be carried out with modifications or equivalent replacements, without departing from the spirit and scope of the technical solution, and such modifications or variations should be included in the scope of the claims of the present invention.

What is claimed is:

1. A method for preparing a supported Ru and/or Ni catalyst, comprising:
mixing a magnesium precursor, a zinc precursor, or a nickel precursor with an aluminum precursor in solid phase to form a first mixture;
adding an auxiliary agent to the first mixture to form a second mixture, wherein the auxiliary agent is to increase a specific surface area;
calcining the second mixture at a first temperature to obtain a spinel carrier;
placing the spinel carrier in a solution of a Ru and/or Ni metal salt to impregnate the spinel carrier with the Ru and/or Ni metal salt to obtain an impregnated carrier; and
after drying, calcining the impregnated carrier at a second temperature to obtain the supported Ru and/or Ni catalyst.

2. The method for preparing a supported Ru and/or Ni catalyst according to claim 1, wherein the spinel carrier comprises a composition selected from the group consisting of MgAl₂O₄, ZnAl₂O₄, and NiAl₂O₄;
wherein the aluminum precursor is one selected from the group consisting of alumina, aluminum nitrate, pseudoboehmite, aluminum hydroxide, basic aluminum carbonate, and a combination thereof;
wherein the magnesium precursor is one selected from the group consisting of magnesium oxide, magnesium carbonate, magnesium hydroxide, and a combination thereof;
wherein the zinc precursor is ba one selected from the group consisting of sic zinc carbonate, zinc nitrate, zinc hydroxide, any and a combination thereof; and
wherein the nickel precursor is one selected from the group consisting of nickel nitrate or nickel hydroxide, any and a combination thereof.

3. The method for preparing a supported Ru and/or Ni catalyst according to claim 1, wherein a molar ratio of divalent metal ions to Al is 0.5:1-1:4, wherein the divalent metal ions include Mg²⁺ from the magnesium precursor, Zn²⁺ from the zinc precursor, Ni²⁺ from the nickel precursor, or a combination thereof, and wherein Al is from the aluminum precursor.

4. The method for preparing a supported Ru and/or Ni catalyst according to claim 1, wherein the auxiliary agent is polyphosphoric acid, boric acid, silicic acid, sodium silicate, phosphate, or a combination thereof.

5. The method for preparing a supported Ru and/or Ni catalyst according to claim 1, wherein a weight ratio of the auxiliary agent is: 0.5-10 wt % of a total weight of the second mixture.

6. The method for preparing a supported Ru and/or Ni catalyst according to claim 1, wherein the first temperature is 500-700° C., and a heating rate is 1-10° C./min.

7. The method for preparing a supported Ru and/or Ni catalyst according to claim 1, wherein a drying temperature is 70-120° C., and a drying time is 0.5-24 h.

8. The method for preparing a supported Ru and/or Ni catalyst according to claim 1, wherein in the supported Ru and/or Ni catalyst, a load of Ru and/or Ni is: 10-30 wt % of Ni and/or 0.5-12 wt % of Ru, based on a total weight of the supported Ru and/or Ni catalyst.

9. The method for preparing a supported Ru and/or Ni catalyst according to claim 1, wherein the Ni metal salt is Ni(NO₃)₂, NiCl₂, Ni(CH₃COO)₂, or a combination thereof; and wherein the Ru metal salt is Ru(NO₃)₃, RuCl₃, K₂RuO₄, or a combination thereof.

10. The supported Ru and/or Ni catalyst prepared by the method according to claim 1.

11. The supported Ru and/or Ni catalyst prepared by the method according to claim 2.

12. The supported Ru and/or Ni catalyst prepared by the method according to claim 3.

13. The supported Ru and/or Ni catalyst prepared by the method according to claim 4.

14. The supported Ru and/or Ni catalyst prepared by the method according to claim 5.

15. The supported Ru and/or Ni catalyst prepared by the method according to claim 6.

16. The supported Ru and/or Ni catalyst prepared by the method according to claim 7.

17. The supported Ru and/or Ni catalyst prepared by the method according to claim 8.

18. The supported Ru and/or Ni catalyst prepared by the method according to claim 9.
